(19) United States
(12) Patent Application Publication
(10) Pub. No.: US 2026/0213852 A1
(43) Pub. Date: Jul. 23, 2026

(54) OPTICAL RECEIVING APPARATUS AND SIGNAL PROCESSING METHOD

(71) Applicant: NTT, Inc., Tokyo (JP)

(72) Inventors: Kyo MINOGUCHI, Musashino-shi (JP); Etsushi YAMAZAKI, Musashino-shi (JP); Fukutaro HAMAOKA, Musashino-shi (JP); Kengo HORIKOSHI, Musashino-shi (JP); Masanori NAKAMURA, Musashino-shi (JP); Kohei SAITO, Musashino-shi (JP)

(73) Assignee: NTT, Inc., Tokyo (JP)

(21) Appl. No.: 19/142,441

(22) PCT Filed: Jan. 27, 2023
(86) PCT No.: PCT/JP2023/002567

§ 371 Date: Jun. 23, 2025

(51) Int. Cl. H04B 10/61

(52) U.S. Cl. CPC H04B 10/613; H04B 10/6162; H04B 10/6165

(57) ABSTRACT

An optical reception device includes a coherent optical reception unit that receives a polarization multiplexed signal generated on the basis of a digital modulation signal generated by phase modulation or quadrature amplitude modulation with coherent detection, a waveform distortion compensation unit that compensates for a transmission line distortion generated in an optical transmission line with respect to the polarization multiplexed signal, a plurality of IQ distortion compensation units that compensate for at least an IQ imbalance or a DC component offset of a signal subjected to transmission line distortion compensation, a plurality of error calculation units that calculate each polarization error obtained from an output signal of each of the IQ distortion compensation units, and a plurality of coefficient updating units that update a filter coefficient used in the waveform distortion compensation unit and filter coefficients used in the plurality of IQ distortion compensation units on the basis of a method of determining a filter coefficient on the basis of a model that minimizes a mean square value of each polarization error calculated by each of the plurality of error calculation units, or a method of searching for a filter coefficient for obtaining a minimum value of a mean square error based on an instantaneous value of an error.

### TECHNICAL FIELD

The present invention relates to an optical reception device and a signal processing method.

### BACKGROUND ART

In coherent optical communication, polarization/phase diversity transmission/reception is realized, and digital signal processing utilizing phase information obtained on a reception side is realized (see, for example, Non Patent Literature 1 and Non Patent Literature 2). Transmission line distortions such as polarization mode dispersion and polarization rotation generated during propagation of an optical signal through an optical fiber are equalized by adaptive coefficient update of a digital filter represented by a finite impulse response (FIR) filter. Due to imperfection of a transceiver analog device, a quadrature/amplitude error (IQ Imbalance), a time delay difference (skew), and a DC offset between In-Phase or Quadrature components of a quadrature amplitude modulation (QAM) signal are present, and IQ distortions occur. The IQ distortions can be similarly equalized by adaptive coefficient update of the digital filter (see, for example, Non Patent Literature 3).

### CITATION LIST

### Non Patent Literature

Non Patent Literature 1: Seb J. Savory, “Digital filters for coherent optical receivers”, Vol. 16, Issue 2, pp. 804-817 (2008).
Non Patent Literature 2: K. Kikuchi, “Fundamentals of Coherent Optical Fiber Communications”, in Journal of Lightwave Technology, vol. 34, no. 1, pp. 157-179, 1 Jan. 1, 2016.
Non Patent Literature 3: W. Nam, H. Roh, J. Lee and I. Kang, “Blind Adaptive I/Q Imbalance Compensation Algorithms for Direct-Conversion Receivers”, in IEEE Signal Processing Letters, vol. 19, no. 8, pp. 475-478, August 2012.
Non Patent Literature 4: Y. Fan, X. Chen, W. Zhou, X. Zhou and H. Zhu, “The Comparison of CMA and LMS Equalization Algorithms in Optical Coherent Receivers”, 2010 6th International Conference on Wireless Communications Networking and Mobile Computing (WiCOM), 2010, pp. 1-4, doi: 10.1109/WICOM.2010.5600984.

### SUMMARY OF INVENTION

### Technical Problem

However, in the conventional technique, in order to compensate for a transmission line distortion and an IQ distortion in an optical receiver, coefficient update of different digital filters is performed. Therefore, the configuration of a digital signal processing unit that compensates for the transmission line distortion and the IQ distortion becomes complicated. As a result, there is a problem that the circuit scale of the digital signal processing unit increases.

In view of the above circumstances, an object of the present invention is to provide a technique capable of reducing the circuit scale of a digital signal processing unit that compensates for a transmission line distortion and an IQ distortion as compared with a conventional case in an environment in which the transmission line distortion and the IQ distortion occur simultaneously.

### Solution to Problem

An aspect of the present invention is an optical reception device including a coherent optical reception unit that receives a polarization multiplexed signal generated on the basis of a digital modulation signal generated by phase modulation or quadrature amplitude modulation with coherent detection, a waveform distortion compensation unit that compensates for a transmission line distortion generated in an optical transmission line with respect to the polarization multiplexed signal, a plurality of IQ distortion compensation units that compensate for at least an IQ imbalance or a DC component offset of a signal subjected to transmission line distortion compensation, a plurality of error calculation units that calculate each polarization error obtained from an output signal of each of the IQ distortion compensation units, and a plurality of coefficient updating units that update a filter coefficient used in the waveform distortion compensation unit and filter coefficients used in the plurality of IQ distortion compensation units on the basis of a method of determining a filter coefficient on the basis of a model that minimizes a mean square value of each polarization error calculated by each of the plurality of error calculation units, or a method of searching for a filter coefficient for obtaining a minimum value of a mean square error based on an instantaneous value of an error.

An aspect of the present invention is a signal processing method including receiving a polarization multiplexed signal generated on the basis of a digital modulation signal generated by phase modulation or quadrature amplitude modulation with coherent detection, compensating for a transmission line distortion generated in an optical transmission line with respect to the polarization multiplexed signal, compensating for at least an IQ imbalance or a DC component offset of a signal subjected to transmission line distortion compensation, calculating each polarization error obtained from an output signal subjected to IQ imbalance or DC component offset compensation, and updating a filter coefficient used to compensate for the transmission line distortion and a filter coefficient used to compensate for at least the IQ imbalance or the DC component offset on the basis of a method of determining a filter coefficient on the basis of a model that minimizes a mean square value of each polarization error calculated, or a method of searching for a filter coefficient for obtaining a minimum value of a mean square error based on an instantaneous value of an error.

### Advantageous Effects of Invention

According to the present invention, it is possible to reduce the circuit scale of a digital signal processing unit that compensates for a transmission line distortion and an IQ distortion as compared with a conventional case in an environment in which the transmission line distortion and the IQ distortion occur simultaneously.

### BRIEF DESCRIPTION OF DRAWINGS

FIG. 1 A diagram illustrating a system configuration of an optical transmission system in a first embodiment.

FIG. 2 A diagram illustrating a configuration example of a digital signal processing unit in the first embodiment.

FIG. 3 A diagram illustrating a configuration example of a waveform distortion compensation unit in the first embodiment.

FIG. 4 A diagram illustrating a configuration example of an IQ distortion compensation unit in the first embodiment.

FIG. 5 A flowchart illustrating a flow of signal processing performed by the digital signal processing unit in the first embodiment.

FIG. 6 A diagram illustrating a configuration example of a digital signal processing unit in a second embodiment.

FIG. 7 A diagram illustrating a configuration example of an IQ skew compensation unit in the second embodiment.

FIG. 8 A flowchart illustrating a flow of signal processing performed by a digital signal processing unit in the second embodiment.

### DESCRIPTION OF EMBODIMENTS

Hereinafter, an embodiment of the present invention will be described with reference to the drawings.

### First Embodiment

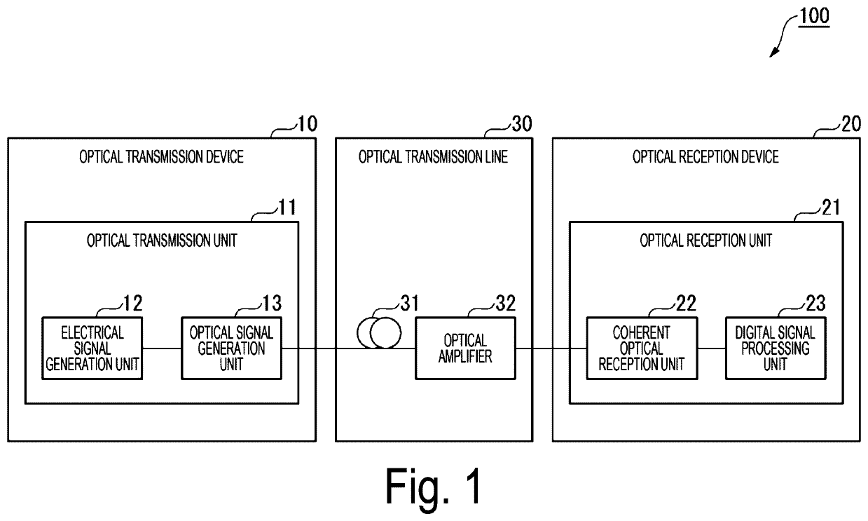

FIG. 1 is a diagram illustrating a system configuration of an optical transmission system 100 in a first embodiment. The optical transmission system 100 includes an optical transmission device 10 and an optical reception device 20. The optical transmission device 10 and the optical reception device 20 are connected via an optical transmission line 30. The optical transmission line 30 transmits an optical signal transmitted by the optical transmission device 10 to the optical reception device 20. The optical transmission line 30 includes an optical fiber 31 and an optical amplifier 32. The optical fiber 31 connects the optical transmission device 10 and the optical reception device 20, and transmits an optical signal transmitted from the optical transmission device 10 to the optical reception device 20. The optical amplifier 32 amplifies an optical signal. Note that, in the optical transmission line 30, a device such as an optical switch or a reproduction repeater may be inserted in the middle of the line.

The optical transmission device 10 transmits a polarization multiplexed signal. The optical transmission device 10 includes an optical transmission unit 11. The optical transmission unit 11 includes an electrical signal generation unit 12 and an optical signal generation unit 13. The electrical signal generation unit 12 encodes transmission data that is an information source, and generates and outputs a digital modulation signal by phase modulation or quadrature amplitude modulation using the encoded transmission data.

The optical signal generation unit 13 converts the digital modulation signal generated by the electrical signal generation unit 12 into a polarization multiplexed signal that is an optical signal, and transmits the polarization multiplexed signal to the optical reception device 20 via the optical transmission line 30.

The optical signal generation unit 13 includes four digital-to-analog converters (for example, a first digital-to-analog converter, a second digital-to-analog converter, a third digital-to-analog converter, and a fourth digital-to-analog converter), four driver amplifiers (for example, a first driver amplifier, a second driver amplifier, a third driver amplifier, and a fourth driver amplifier), two IQ modulators (for example, a first IQ modulator and a second IQ modulator), a laser, a polarization combining unit, and the like.

The first digital-to-analog converter converts an X-polarization I (in-phase) component signal of a digital modulation signal from a digital signal to an analog signal, and outputs the converted analog signal to the first driver amplifier. The second digital-to-analog converter converts an X-polarization Q (quadrature) component signal of the digital modulation signal from a digital signal to an analog signal, and outputs the converted analog signal to the second driver amplifier.

The third digital-to-analog converter converts a Y-polarization I component signal of the digital modulation signal from a digital signal to an analog signal, and outputs the converted analog signal to the third driver amplifier. The fourth digital-to-analog converter converts a Y-polarization Q component signal of the digital modulation signal from a digital signal to an analog signal, and outputs the converted analog signal to the fourth driver amplifier.

The first driver amplifier amplifies the analog signal output from the first digital-to-analog converter and outputs the amplified analog signal to the first IQ modulator. The second driver amplifier amplifies the analog signal output from the second digital-to-analog converter and outputs the amplified analog signal to the first IQ modulator.

The third driver amplifier amplifies the analog signal output from the third digital-to-analog converter and outputs the amplified analog signal to the second IQ modulator. The fourth driver amplifier amplifies the analog signal output from the fourth digital-to-analog converter and outputs the amplified analog signal to the second IQ modulator.

The first IQ modulator modulates an optical signal output from the laser on the basis of the X-polarization I component signal output from the first driver amplifier and the X-polarization Q component signal output from the second driver amplifier to generate an X-polarization optical signal. The first IQ modulator outputs the generated X-polarization optical signal to the polarization combining unit.

The second IQ modulator modulates an optical signal output from the laser on the basis of the Y-polarization I component signal output from the third driver amplifier and the Y-polarization Q component signal output from the fourth driver amplifier to generate a Y-polarization optical signal. The second IQ modulator outputs the generated Y-polarization optical signal to the polarization combining unit.

The polarization combining unit performs polarization multiplexing on the X-polarization optical signal output by the first IQ modulator and the Y-polarization optical signal output by the second IQ modulator to generate a polarization multiplexed signal. The polarization combining unit outputs the generated polarization multiplexed signal to the optical transmission line 30.

The optical reception device 20 receives a polarization multiplexed signal transmitted from the optical transmission device 10. The optical reception device 20 includes an optical reception unit 21. The optical reception unit 21 includes a coherent optical reception unit 22 and a digital signal processing unit 23. The coherent optical reception unit 22 includes therein a polarization separation unit, two 90-degree optical hybrid circuits (for example, a first 90-degree optical hybrid circuit and a second 90-degree optical hybrid circuit), a local oscillator source, a photodetector, and an optical fiber that couples these components. Note that the coherent optical reception unit 22 may include an analog-to-digital converter, or an analog-to-digital converter may be provided between the coherent optical reception unit 22 and the digital signal processing unit 23. Furthermore, an optical attenuator may be provided inside the coherent optical reception unit 22.

The polarization separation unit separates an input polarization multiplexed signal into an X-polarization optical signal and a Y-polarization optical signal. The polarization separation unit outputs the X-polarization optical signal to the first 90-degree optical hybrid circuit, and outputs the Y-polarization optical signal to the second 90-degree optical hybrid circuit.

The first 90-degree optical hybrid circuit causes the X-polarization optical signal and local oscillation light output from the local oscillator source to interfere with each other, and extracts an X-polarization I component optical signal and an X-polarization Q component optical signal.

The second 90-degree optical hybrid circuit causes the Y-polarization optical signal and local oscillation light output from the local oscillator source to interfere with each other, and extracts a Y-polarization I component optical signal and a Y-polarization Q component optical signal.

Four output lights in total, that is, the X-polarization I component optical signal and the X-polarization Q component optical signal extracted by the first 90-degree optical hybrid circuit and the Y-polarization I component optical signal and the Y-polarization Q component optical signal extracted by the second 90-degree optical hybrid circuit are converted from optical signals to analog electrical signals by the photodetector. The analog-to-digital converter converts the analog signal into a digital signal and outputs the digital signal to the digital signal processing unit 23.

When an optical signal propagates through the optical transmission line 30, the signal waveform is distorted by a non-linear optical effect in which the phase of the signal rotates in proportion to the optical power of the signal. The digital signal processing unit 23 takes in a digital signal output from the analog-to-digital converter as a reception signal and performs various types of compensation on the taken reception signal.

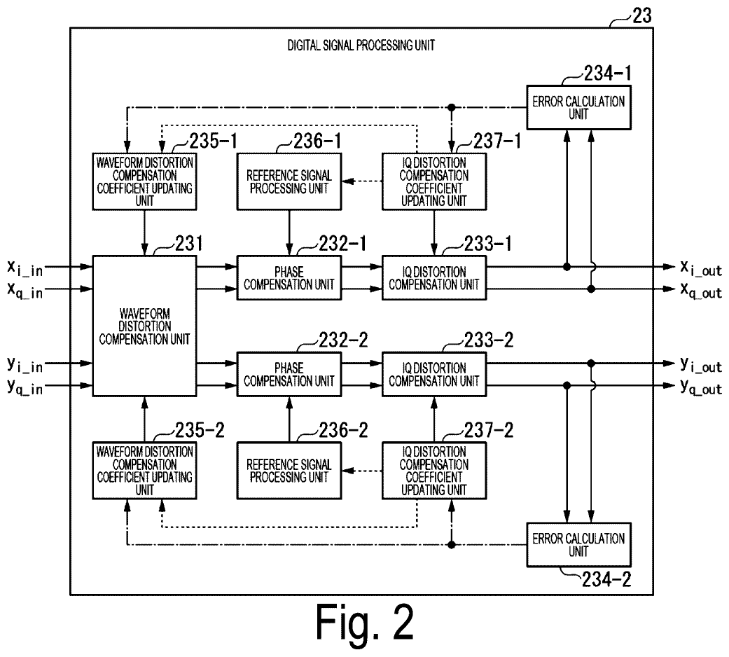

FIG. 2 is a diagram illustrating a configuration example of the digital signal processing unit 23 in the first embodiment. The digital signal processing unit 23 includes a waveform distortion compensation unit 231, phase compensation units 232-1, 232-2, IQ distortion compensation units 233-1, 233-2, error calculation units 234-1, 234-2, waveform distortion compensation coefficient updating units 235-1, 235-2, reference signal processing units 236-1, 236-2, and IQ distortion compensation coefficient updating units 237-1, 237-2. Note that, in the following description, a dotted line connecting the functional units indicates that the updated coefficient is notified, and an alternate long and short dash line connecting the functional units indicates that the error is notified.

The waveform distortion compensation unit 231 receives an X-polarization I component signal x_{i_in}, an X-polarization Q component signal x_{q_in}, a Y-polarization I component signal y_{i_in}, and a Y-polarization Q component signal y_{q_in}, which have been converted into digital signals by the analog-to-digital converter. The waveform distortion compensation unit 231 performs an adaptive equalization process on the input X-polarization I component signal x_{i_in}, the input X-polarization Q component signal x_{q_in}, the input Y-polarization I component signal y_{i_in}, and the input Y-polarization Q component signal y_{q_in} using a digital filter such as an FIR filter (finite impulse response filter) based on the filter coefficient updated by the waveform distortion compensation coefficient updating unit 235-1, 235-2. As a result, the waveform distortion compensation unit 231 compensates for a distortion (hereinafter, referred to as “optical transmission line distortion”) generated in the optical transmission line 30. Note that, at the start of processing (for example, at an initial time), the waveform distortion compensation unit 231 uses a preset filter coefficient.

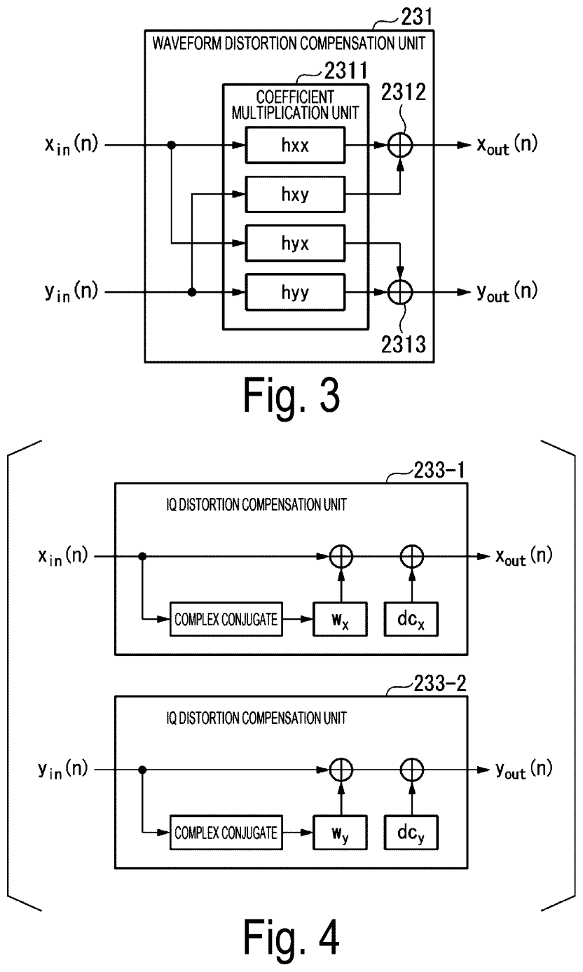

The waveform distortion compensation unit 231 has a configuration of a 2×2 FIR filter including an FIR filter. FIG. 3 is a diagram illustrating a configuration example of the waveform distortion compensation unit 231 in the first embodiment. The waveform distortion compensation unit 231 includes a coefficient multiplication unit 2311, an addition unit 2312, and an addition unit 2313. The coefficient multiplication unit 2311 multiplies an input signal by a filter coefficient. The addition unit 2312 adds input signals. The addition unit 2313 adds input signals.

In the configuration of FIG. 3, xᵢₙ(n), yᵢₙ(n), xₒᵤₜ(n), and yₒᵤₜ(n) are defined by the following Expressions (1). Here, n represents time.

$$[ Math . 1 ]$$

$${x}_{in} ( n ) = {x}_{i \_ in} ( n ) + j \cdot {x}_{q \_ in} ( n ) \qquad ( 1 )$$

$${y}_{in} ( n ) = {y}_{i \_ in} ( n ) + j \cdot {y}_{q \_ in} ( n )$$

$${x}_{out} ( n ) = {x}_{i \_ out} ( n ) + j \cdot {x}_{q \_ out} ( n )$$

$${y}_{out} ( n ) = {y}_{i \_ out} ( n ) + j \cdot {y}_{q \_ out} ( n )$$

In Expressions (1), x_{i/q_in}(n) represents an X-polarization input vector (in-phase/quadrature component), x_{i/q_out}(n) represents an X-polarization output scalar (in-phase/quadrature component), y_{i/q_in}(n) represents a Y-polarization input vector (in-phase/quadrature component), and y_{i/q_out}(n) represents a Y-polarization output scalar (in-phase/quadrature component).

In the coefficient multiplication unit 2311, hₓₓ represents a filter coefficient vector (X-polarization input/X-polarization output), h_{xy} represents a filter coefficient vector (X-polarization input/Y-polarization output), h_{yx} represents a filter coefficient vector (Y-polarization input/X-polarization output), and h_{yy} represents a filter coefficient vector (Y-polarization input/Y-polarization output). xₒᵤₜ(n) and yₒᵤₜ(n) output from the waveform distortion compensation unit 231 can be expressed by the following Expressions (2).

$$[ Math . 2 ]$$

$${x}_{out} ( n ) = {x}_{in} ( n ) \cdot {h}_{xx} + {y}_{in} ( n ) \cdot {h}_{xy} \qquad ( 2 )$$

$${y}_{out} ( n ) = {x}_{in} ( n ) \cdot {h}_{yx} + {y}_{in} ( n ) \cdot {h}_{yy}$$

Referring back to FIG. 2, the description will be continued.

The phase compensation unit 232-1, 232-2 compensates for the phase rotation of the input signal using a reference signal provided by the reference signal processing unit 236-1, 236-2.

The IQ distortion compensation unit 233-1, 233-2 compensates for IQ distortions (IQ imbalance and direct current (DC) offset) of the input signal. IQ imbalance represents an error in amplitude and an error in orthogonality between an In-Phase component (in-phase component) and a Quadrature component (quadrature component) of a signal. Note that the IQ distortion compensation unit 233-1, 233-2 is only required to compensate for at least an IQ imbalance or a DC offset (offset of a DC component). The IQ distortion compensation unit 233-1, 233-2 has a configuration of, for example, a Widely-Linear Equalizer. Note that the IQ distortion compensation unit 233-1, 233-2 may have a configuration of a 2×2 FIR filter including an FIR filter.

FIG. 4 is a diagram illustrating a configuration example of the IQ distortion compensation units 233-1, 233-2 in the first embodiment. The upper diagram in FIG. 4 illustrates a configuration example of the IQ distortion compensation unit 233-1 that compensates for an X-polarization IQ distortion, and the lower diagram in FIG. 4 illustrates a configuration example of the IQ distortion compensation unit 233-2 that compensates for a Y-polarization IQ distortion. In FIG. 4, wₓ represents an X-polarization filter coefficient scalar, dcₓ represents a DC offset compensation coefficient (complex scalar) for compensating for X-polarization DC offset, w_{y} represents a Y-polarization filter coefficient scalar, and dc_{y} represents a DC offset compensation coefficient (complex scalar) for compensating for a Y-polarization DC offset. In the configuration of FIG. 4, xᵢₙ(n), yᵢₙ(n), xₒᵤₜ(n), and yₒᵤₜ(n) are defined by the following Expressions (3).

$$[ Math . 3 ]$$

$${x}_{in} ( n ) = {x}_{i \_ in} ( n ) + j \cdot {x}_{q \_ in} ( n ) \qquad ( 3 )$$

$${y}_{in} ( n ) = {y}_{i \_ in} ( n ) + j \cdot {y}_{q \_ in} ( n )$$

$${x}_{out} ( n ) = {x}_{i \_ out} ( n ) + j \cdot {x}_{q \_ out} ( n )$$

$${y}_{out} ( n ) = {y}_{i \_ out} ( n ) + j \cdot {y}_{q \_ out} ( n )$$

In Expressions (3), x_{i/q_in}(n) represents an X-polarization input scalar (in-phase/quadrature component), x_{i/q_out}(n) represents an X-polarization output scalar (in-phase/quadrature component), y_{i/q_in}(n) represents a Y-polarization input scalar (in-phase/quadrature component), and y_{i/q_out}(n) represents a Y-polarization output scalar (in-phase/quadrature component). The X-polarization signal xₒᵤₜ(n) output from the IQ distortion compensation unit 233-1 and the Y-polarization signal yₒᵤₜ(n) output from the IQ distortion compensation unit 233-2 can be expressed by the following Expressions (4).

$$[ Math . 4 ]$$

$${x}_{out} ( n ) = {x}_{in} ( n ) + conj ( {x}_{in} ( n ) ) \cdot {w}_{x} + {dc}_{x} \qquad ( 4 )$$

$${y}_{out} ( n ) = {y}_{in} ( n ) + conj ( {y}_{in} ( n ) ) \cdot {w}_{y} + {dc}_{y}$$

As illustrated in FIG. 4, the IQ distortion compensation unit 233-1, 233-2 is configured to multiply the complex conjugate value of the input signal by the filter coefficient wₓ, w_{y} defined by the complex scalar, and output the result (xₒᵤₜ(n), yₒᵤₜ(n)) obtained by adding the original input value (xᵢₙ(n), yᵢₙ(n)) and the DC offset compensation coefficient dcₓ, dc_{y} to the result of multiplication.

Referring back to FIG. 2, the description will be continued.

The error calculation unit 234-1, 234-2 calculates an error of the output signal of the IQ distortion compensation unit 233-1, 233-2. The error calculation unit 234-1 receives an X-polarization I component signal and an X-polarization Q component signal, which are output signals of the IQ distortion compensation unit 233-1. The error calculation unit 234-1 calculates the error between the input X-polarization I component signal and the input X-polarization Q component signal. The error calculation unit 234-1 outputs the calculated X-polarization error to the waveform distortion compensation coefficient updating unit 235-1 and the IQ distortion compensation coefficient updating unit 237-1.

The error calculation unit 234-2 receives a Y-polarization I component signal and a Y-polarization Q component signal, which are output signals of the IQ distortion compensation unit 233-2. The error calculation unit 234-2 calculates the error between the input Y-polarization I component signal and the input Y-polarization Q component signal. The error calculation unit 234-2 outputs the calculated Y-polarization error to the waveform distortion compensation coefficient updating unit 235-2 and the IQ distortion compensation coefficient updating unit 237-2.

The waveform distortion compensation coefficient updating unit 235-1 updates the filter coefficients hₓₓ, h_{xy} used in the waveform distortion compensation unit 231 on the basis of a value obtained by transforming each polarization error by a linear process using a filter coefficient used in the IQ distortion compensation unit 233-1. Specifically, the waveform distortion compensation coefficient updating unit 235-1 updates the filter coefficients hₓₓ, h_{xy} used in the waveform distortion compensation unit 231 on the basis of the following Expressions (5) using the error output from the error calculation unit 234-1 and the filter coefficient set in the IQ distortion compensation unit 233-1.

The waveform distortion compensation coefficient updating unit 235-2 updates the filter coefficients h_{yx}, h_{yy} used in the waveform distortion compensation unit 231 on the basis of a value obtained by transforming each polarization error by a linear process using a filter coefficient used in the IQ distortion compensation unit 233-2. Specifically, the waveform distortion compensation coefficient updating unit 235-2 updates the filter coefficients h_{yx}, h_{yy} used in the waveform distortion compensation unit 231 on the basis of the following Expressions (5) using the error output from the error calculation unit 234-2 and the filter coefficient set in the IQ distortion compensation unit 233-2. For example, the waveform distortion compensation coefficient updating unit 235-1, 235-2 may update the filter coefficient using least mean square (LMS) algorithm. The LMS algorithm is an algorithm that searches for a filter coefficient for obtaining the minimum value of a mean square error based on the instantaneous value of the error. The waveform distortion compensation coefficient updating unit 235-1, 235-2 is an aspect of a coefficient updating unit. Note that the waveform distortion compensation coefficient updating unit 235-1, 235-2 may update the filter coefficient used in the waveform distortion compensation unit 231 on the basis of a method of determining a filter coefficient on the basis of a model of minimizing a mean square value of an error, for example, recursive least-squares (RLS) algorithm.

$$[ Math . 5 ]$$

$${h}_{xx} ( n + 1 ) = {h}_{xx} ( n ) + μ \cdot {e}^{- j {ϕ}_{x}} \cdot conj ( {x}_{in} ( n ) ) \cdot ( {e}_{x} + {w}_{x} ( n ) \cdot conj ( {e}_{x} ) ) \qquad ( 5 )$$

$${h}_{xy} ( n + 1 ) = {h}_{xy} ( n ) + μ \cdot {e}^{- j {ϕ}_{x}} \cdot conj ( {y}_{in} ( n ) ) \cdot ( {e}_{x} + {w}_{x} ( n ) \cdot conj ( {e}_{x} ) )$$

$${h}_{yx} ( n + 1 ) = {h}_{yx} ( n ) + μ \cdot {e}^{- j {ϕ}_{y}} \cdot conj ( {x}_{in} ( n ) ) \cdot ( {e}_{y} + {w}_{y} ( n ) \cdot conj ( {e}_{y} ) )$$

$${h}_{yy} ( n + 1 ) = {h}_{yy} ( n ) + μ \cdot {e}^{- j {ϕ}_{y}} \cdot conj ( {y}_{in} ( n ) ) \cdot ( {e}_{y} + {w}_{y} ( n ) \cdot conj ( {e}_{y} ) )$$

In Expressions (5), μ represents the step size of the waveform distortion compensation coefficient updating unit 235-1, 235-2, φₓ represents an X-polarization phase compensation angle, φ_{y} represents a Y-polarization phase compensation angle, eₓ represents an X-polarization error calculated by the error calculation unit 234-1, e_{y} represents a Y-polarization error calculated by the error calculation unit 234-2, wₓ(n) represents the filter coefficient of the IQ distortion compensation unit 233-1 set at a time n by the IQ distortion compensation coefficient updating unit 237-1, w_{y}(n) represents the filter coefficient of the IQ distortion compensation unit 233-2 set at the time n by the IQ distortion compensation coefficient updating unit 237-2, and conj(*) represents the complex conjugate of a complex number*. As shown in Expressions (5), the waveform distortion compensation coefficient updating unit 235-1, 235-2 updates the filter coefficient of the waveform distortion compensation unit 231 on the basis of the result obtained by multiplying the complex conjugate value of the error obtained from the error calculation unit 234-1, 234-2 by the filter coefficient wₓ(n), w_{y}(n) set in the IQ distortion compensation unit 233-1, 233-2 and then adding the original error to the result of multiplication.

The reference signal processing unit 236-1, 236-2 converts a reference signal that is known on the reception side and used for updating the amount of compensation in the phase compensation unit 232-1, 232-2 by using the coefficient of the IQ distortion compensation unit 233-1, 233-2 set by the IQ distortion compensation coefficient updating unit 237-1, 237-2 to obtain a new reference signal.

The conversion process by the reference signal processing unit 236-1, 236-2 generates a reference signal in which waveform distortion (for example, waveform distortion that can be compensated only by the IQ distortion compensation unit 233-1, 233-2) that cannot be compensated by the waveform distortion compensation unit 231 is taken into consideration, and reflects the reference signal in updating the amount of phase compensation in the phase compensation unit 232-1, 232-2. As a result, the operation of the phase compensation unit 232-1, 232-2 is made highly accurate, and the signal quality is improved.

The IQ distortion compensation coefficient updating unit 237-1 updates the filter coefficient wₓ used in the IQ distortion compensation unit 233-1 on the basis of the following Expressions (6) using the error output from the error calculation unit 234-1. The IQ distortion compensation coefficient updating unit 237-2 updates the filter coefficient w_{y} used in the IQ distortion compensation unit 233-2 on the basis of the following Expressions (6) using the error output from the error calculation unit 234-2. The IQ distortion compensation coefficient updating unit 237-1, 237-2 may update the filter coefficient using LMS algorithm. The IQ distortion compensation coefficient updating unit 237-1, 237-2 is an aspect of the coefficient updating unit. Note that the IQ distortion compensation coefficient updating unit 237-1, 237-2 may update the filter coefficient wₓ, w_{y} used in the IQ distortion compensation unit 233-1, 233-2 and the waveform distortion compensation unit 231 on the basis of a method of determining a filter coefficient on the basis of a model of minimizing a mean square value of an error, for example, RLS.

$$[ Math . 6 ]$$

$${w}_{x} ( n + 1 ) = {w}_{x} ( n ) + β \cdot {e}_{x} \cdot {x}_{in} ( n ) \qquad ( 6 )$$

$${w}_{y} ( n + 1 ) = {w}_{y} ( n ) + β \cdot {e}_{y} \cdot {y}_{in} ( n )$$

In Expressions (6), β represents the step size of the IQ distortion compensation coefficient updating unit 237-1, 237-2. As shown in Expressions (6), the IQ distortion compensation coefficient updating unit 237-1, 237-2 updates the filter coefficient wₓ(n), w_{y}(n) used in the IQ distortion compensation unit 233-1, 233-2 on the basis of the result obtained by adding the filter coefficient wₓ(n), w_{y}(n) set in the IQ distortion compensation unit 233-1, 233-2 to each polarization error.

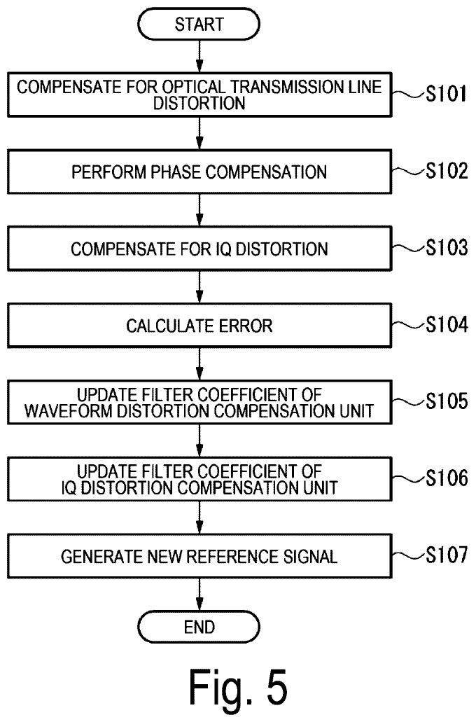

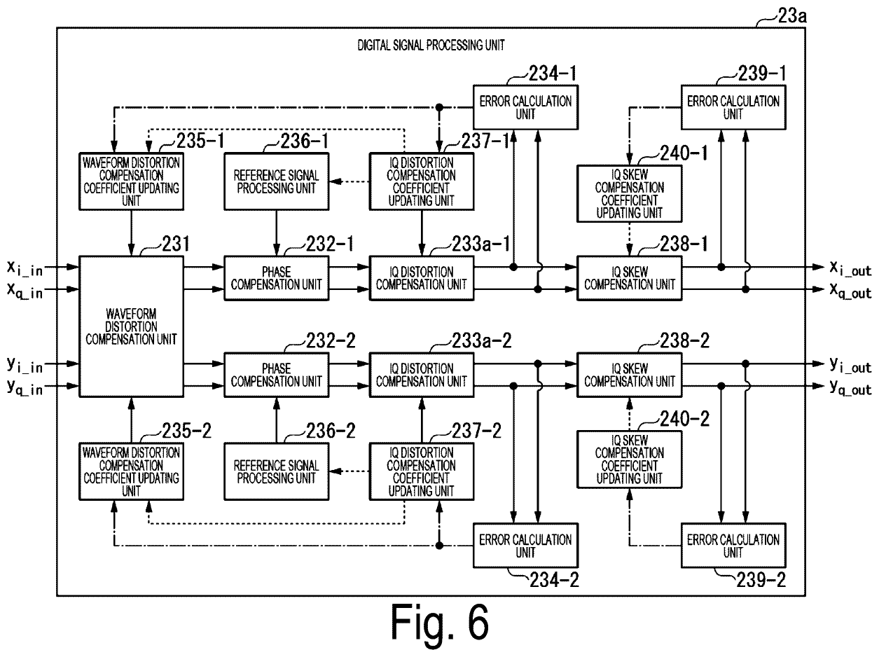

FIG. 5 is a flowchart illustrating a flow of signal processing performed by the digital signal processing unit 23 in the first embodiment.

The waveform distortion compensation unit 231 performs an adaptive equalization process on the input X-polarization I component signal x_{i_in}, the input X-polarization Q component signal x_{q_in}, the input Y-polarization I component signal y_{i_in}, and the input Y-polarization Q component signal y_{q_in} using a digital filter such as an FIR filter (finite impulse response filter) based on the filter coefficient updated by the waveform distortion compensation coefficient updating unit 235-1, 235-2. As a result, the waveform distortion compensation unit 231 compensates for an optical transmission line distortion (step S101). The waveform distortion compensation unit 231 outputs the X-polarization I component signal and the X-polarization Q component signal subjected to optical transmission line distortion compensation to the phase compensation unit 232-1, and outputs the Y-polarization I component signal and the Y-polarization Q component signal subjected to optical transmission line distortion compensation to the phase compensation unit 232-2.

The phase compensation unit 232-1 compensates for phase rotation of the X-polarization I component signal and the X-polarization Q component signal subjected to optical transmission line distortion compensation, which are output from the waveform distortion compensation unit 231, using the reference signal provided by the reference signal processing unit 236-1. The phase compensation unit 232-1 outputs the X-polarization I component signal and the X-polarization Q component signal subjected to phase compensation to the IQ distortion compensation unit 233-1. The phase compensation unit 232-2 compensates for phase rotation of the Y-polarization I component signal and the Y-polarization Q component signal subjected to optical transmission line distortion compensation, which are output from the waveform distortion compensation unit 231, using the reference signal provided by the reference signal processing unit 236-2. The phase compensation unit 232-2 outputs the Y-polarization I component signal and the Y-polarization Q component signal subjected to phase compensation to the IQ distortion compensation unit 233-2 (step S102).

The IQ distortion compensation unit 233-1 compensates for IQ distortions (IQ imbalance and DC offset) of the X-polarization I component signal and the X-polarization Q component signal subjected to phase compensation, which are output from the phase compensation unit 232-1. The IQ distortion compensation unit 233-1 outputs the X-polarization I component signal and the X-polarization Q component signal subjected to IQ distortion compensation to the subsequent processing unit and the error calculation unit 234-1. The IQ distortion compensation unit 233-2 compensates for IQ distortions (IQ imbalance and DC offset) of the Y-polarization I component signal and the Y-polarization Q component signal subjected to phase compensation, which are output from the phase compensation unit 232-2. The IQ distortion compensation unit 233-2 outputs the Y-polarization I component signal and the Y-polarization Q component signal subjected to IQ distortion compensation to the subsequent processing unit and the error calculation unit 234-2 (step S103).

The error calculation unit 234-1 calculates the error between the X-polarization I component signal and the X-polarization Q component signal subjected to IQ distortion compensation, which are output from the IQ distortion compensation unit 233-1. The error calculation unit 234-1 outputs the calculated X-polarization error to the waveform distortion compensation coefficient updating unit 235-1 and the IQ distortion compensation coefficient updating unit 237-1. The error calculation unit 234-2 calculates the error between the Y-polarization I component signal and the Y-polarization Q component signal subjected to IQ distortion compensation, which are output from the IQ distortion compensation unit 233-2. The error calculation unit 234-2 outputs the calculated Y-polarization error to the waveform distortion compensation coefficient updating unit 235-2 and the IQ distortion compensation coefficient updating unit 237-2 (step S104).

The waveform distortion compensation coefficient updating unit 235-1 updates the filter coefficients hₓₓ, h_{xy} used in the waveform distortion compensation unit 231 on the basis of the above Expressions (5) using the error output from the error calculation unit 234-1, the filter coefficients hₓₓ(n), h_{xy}(n) set in the IQ distortion compensation unit 233-1 at the time n, and the filter coefficient wₓ(n) of the IQ distortion compensation unit 233-1 set at the time n. The waveform distortion compensation coefficient updating unit 235-1 outputs the updated filter coefficients hₓₓ, h_{xy} to the waveform distortion compensation unit 231. As a result, the waveform distortion compensation unit 231 compensates for the optical transmission line distortion using the filter coefficients hₓₓ, h_{xy} updated by the waveform distortion compensation coefficient updating unit 235-1 at the time of the next processing.

The waveform distortion compensation coefficient updating unit 235-2 updates the filter coefficients h_{yx}, h_{yy} used in the waveform distortion compensation unit 231 on the basis of the above Expressions (5) using the error output from the error calculation unit 234-2, the filter coefficients h_{yx}(n), h_{yy}(n) set in the IQ distortion compensation unit 233-2 at the time n, and the filter coefficient w_{y}(n) of the IQ distortion compensation unit 233-2 set at the time n. The waveform distortion compensation coefficient updating unit 235-2 outputs the updated filter coefficients h_{yx}, h_{yy} to the waveform distortion compensation unit 231. As a result, the waveform distortion compensation unit 231 compensates for the optical transmission line distortion using the filter coefficients h_{yx}, h_{yy} updated by the waveform distortion compensation coefficient updating unit 235-2 at the time of the next processing (step S105).

The IQ distortion compensation coefficient updating unit 237-1 updates the filter coefficient wₓ used in the IQ distortion compensation unit 233-1 on the basis of the above Expressions (6) using the error output from the error calculation unit 234-1. The IQ distortion compensation coefficient updating unit 237-1 outputs the updated filter coefficient wₓ to the IQ distortion compensation unit 233-1 and the reference signal processing unit 236-1. As a result, the IQ distortion compensation unit 233-1 compensates for the IQ distortion using the filter coefficient wₓ updated by the IQ distortion compensation coefficient updating unit 237-1 at the time of the next processing.

The IQ distortion compensation coefficient updating unit 237-2 updates the filter coefficient w_{y} used in the IQ distortion compensation unit 233-2 on the basis of the above Expressions (6) using the error output from the error calculation unit 234-2. The IQ distortion compensation coefficient updating unit 237-2 outputs the updated filter coefficient w_{y} to the IQ distortion compensation unit 233-2 and the reference signal processing unit 236-2. As a result, the IQ distortion compensation unit 233-2 compensates for the IQ distortion using the filter coefficient w_{y} updated by the IQ distortion compensation coefficient updating unit 237-2 at the time of the next processing (step S106).

The reference signal processing unit 236-1 converts a reference signal that is known on the reception side and used for updating the amount of compensation in the phase compensation unit 232-1 by affine transformation using the updated filter coefficient wₓ output from the IQ distortion compensation coefficient updating unit 237-1 to obtain a new reference signal. The reference signal processing unit 236-2 outputs the new reference signal to the phase compensation unit 232-2. The reference signal processing unit 236-2 converts a reference signal that is known on the reception side and used for updating the amount of compensation in the phase compensation unit 232-2 by affine transformation using the updated filter coefficient w_{y} output from the IQ distortion compensation coefficient updating unit 237-2 to obtain a new reference signal. The reference signal processing unit 236-2 outputs the new reference signal to the phase compensation unit 232-2 (step S107).

Note that in FIG. 5, the order of processes in steps S105 and S106 may be reversed.

According to the optical transmission system 100 with the above configuration, the optical reception device 20 includes the coherent optical reception unit 22 that receives a polarization multiplexed signal generated on the basis of a digital modulation signal generated by phase modulation or quadrature amplitude modulation with coherent detection, the waveform distortion compensation unit 231 that compensates for a transmission line distortion generated in an optical transmission line with respect to the polarization multiplexed signal, a plurality of IQ distortion compensation units 233-1 and 233-2 that compensate for at least an IQ imbalance or a DC component offset of a signal subjected to transmission line distortion compensation, a plurality of error calculation units 234-1 and 234-2 that calculate each polarization error obtained from an output signal of each of the IQ distortion compensation units 233-1 and 233-2, and a plurality of coefficient updating units (for example, the waveform distortion compensation coefficient updating unit 235-1, 235-2 and the IQ distortion compensation coefficient updating unit 237-1, 237-2) that update a filter coefficient used in the waveform distortion compensation unit 231 and filter coefficients used in the plurality of IQ distortion compensation units 233-1 and 233-2 on the basis of a method of determining the filter coefficient on the basis of a model that minimizes the mean square value of each polarization error calculated by each of the plurality of error calculation units 234-1 and 234-2, for example, RLS algorithm, or a method of searching for the filter coefficient for obtaining the minimum value of a mean square error based on the instantaneous value of the error, for example, LMS algorithm. As described above, in order to compensate for the optical transmission line distortion and the IQ distortion, the optical reception device 20 collectively updates the filter coefficient used in the waveform distortion compensation unit 231 and the filter coefficients used in the plurality of IQ distortion compensation units 233-1 and 233-2 on the basis of each polarization error. As a result, it is not necessary to update the coefficients of the different digital filters as in the conventional case. Therefore, it is possible to prevent the configuration of the digital signal processing unit from becoming complicated, and as a result, the circuit scale of the digital signal processing unit can be reduced.

### (First Modification)

In the above embodiment, the phase compensation unit 232-1, 232-2 is provided at the subsequent stage of the waveform distortion compensation unit 231 in the digital signal processing unit 23, but the phase compensation unit 232-1, 232-2 may be provided at the preceding stage of the waveform distortion compensation unit 231, or may be provided at each of the preceding stage and the subsequent stage of the waveform distortion compensation unit 231.

### (Second Modification)

In the above embodiment, the filter coefficient wₓ, w_{y} in the configuration of the IQ distortion compensation unit 233-1, 233-2 is a scalar. The IQ distortion compensation unit 233-1, 233-2 may be configured to compensate for IQ inter-lane skew by using the filter coefficient wₓ, w_{y} as a vector. With this configuration, while the power of the IQ distortion compensation unit 233-1, 233-2 in skew compensation increases, the IQ distortion compensation unit 233-1, 233-2 of the first embodiment can compensate for the IQ inter-lane skew in addition to the IQ imbalance and the DC offset.

### Second Embodiment

In the first embodiment, the IQ distortion compensation unit compensates for the IQ distortions (IQ imbalance and DC offset). In a second embodiment, a configuration in which an IQ distortion compensation unit compensates for an IQ imbalance and a DC offset, and another functional unit at the subsequent stage of the IQ distortion compensation unit compensates for an IQ inter-lane skew will be described. Note that in the second embodiment, the system configuration is similar to that of the first embodiment, and the configuration of the digital signal processing unit is different from that of the first embodiment.

FIG. 6 is a diagram illustrating a configuration example of a digital signal processing unit 23a in a second embodiment. The digital signal processing unit 23a includes the waveform distortion compensation unit 231, the phase compensation units 232-1, 232-2, IQ distortion compensation units 233a-1, 233a-2, the error calculation units 234-1, 234-2, the waveform distortion compensation coefficient updating units 235-1, 235-2, the reference signal processing units 236-1, 236-2, the IQ distortion compensation coefficient updating units 237-1, 237-2, IQ skew compensation units 238-1, 238-2, error calculation units 239-1, 239-2, and IQ skew compensation coefficient updating units 240-1, 240-2.

The digital signal processing unit 23a is different from the digital signal processing unit 23 in that the IQ distortion compensation units 233a-1, 233a-2 are provided instead of the IQ distortion compensation units 233-1, 233-2, and that the IQ skew compensation units 238-1, 238-2, the error calculation units 239-1, 239-2, and the IQ skew compensation coefficient updating units 240-1, 240-2 are newly provided. Other configurations of the digital signal processing unit 23a are similar to those of the digital signal processing unit 23. Hereinafter, differences will be mainly described.

The IQ distortion compensation unit 233a-1, 233a-2 compensates for an IQ distortion (at least IQ imbalance or DC offset) of an input signal.

The IQ skew compensation unit 238-1, 238-2 compensates for only the IQ inter-lane skew. The IQ skew compensation unit 238-1, 238-2 has a configuration of a 2×2 FIR filter including an FIR filter. Note that the IQ skew compensation unit 238-1, 238-2 has a configuration of, for example, a Widely-Linear Equalizer.

The error calculation unit 239-1, 239-2 calculates an error of the output signal of the IQ skew compensation unit 238-1, 238-2. The error calculation unit 239-1 receives an X-polarization I component signal and an X-polarization Q component signal, which are output signals of the IQ skew compensation unit 238-1. The error calculation unit 239-1 calculates the error between the input X-polarization I component signal and the input X-polarization Q component signal. The error calculation unit 239-1 outputs the calculated X-polarization error to the IQ skew compensation coefficient updating unit 240-1.

The error calculation unit 239-2 receives a Y-polarization I component signal and a Y-polarization Q component signal, which are output signals of the IQ skew compensation unit 238-2. The error calculation unit 239-2 calculates the error between the input Y-polarization I component signal and the input Y-polarization Q component signal. The error calculation unit 239-2 outputs the calculated Y-polarization error to the IQ skew compensation coefficient updating unit 240-2.

The IQ skew compensation coefficient updating unit 240-1 updates the filter coefficient used in the IQ skew compensation unit 238-1 using the error output from the error calculation unit 239-1. The IQ skew compensation coefficient updating unit 240-2 updates the filter coefficient used in the IQ skew compensation unit 238-2 using the error output from the error calculation unit 239-2. For example, the IQ skew compensation coefficient updating unit 240-1, 240-2 may update the filter coefficient using LMS algorithm. Note that the IQ skew compensation coefficient updating unit 240-1, 240-2 may update the filter coefficient used in the IQ skew compensation unit 238-1, 238-2 on the basis of a method of determining a filter coefficient on the basis of a model of minimizing a mean square value of an error, for example, RLS.

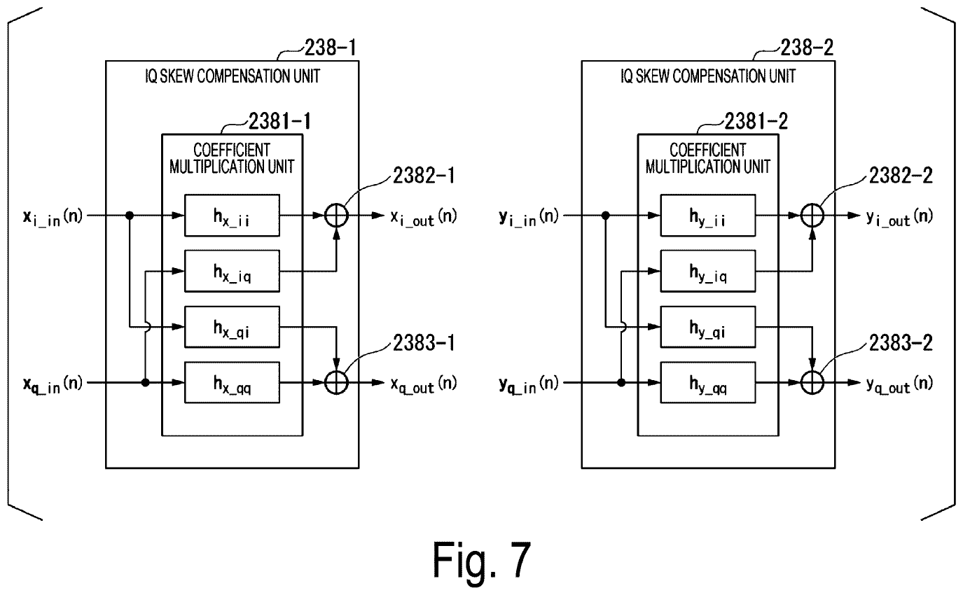

FIG. 7 is a diagram illustrating a configuration example of the IQ skew compensation unit 238-1, 238-2 in the second embodiment. The IQ skew compensation units 238-1, 238-2 have the same configuration. The IQ skew compensation unit 238-1 includes a coefficient multiplication unit 2381-1, an addition unit 2382-1, and an addition unit 2383-1. The IQ skew compensation unit 238-2 includes a coefficient multiplication unit 2381-2, an addition unit 2382-2, and an addition unit 2383-2. The coefficient multiplication unit 2381-1, 2381-2 multiplies an input signal by a filter coefficient. The addition unit 2382-1, 2382-2 adds input signals. The addition unit 2383-1, 2383-2 adds input signals.

In the coefficient multiplication unit 2381-1, h_{x_ii} represents a filter coefficient vector (X-polarization i component input/X-polarization i component output), h_{x_iq} represents a filter coefficient vector (X-polarization Q component input/X-polarization i component output), h_{x_qi} represents a filter coefficient vector (X-polarization i component input/X-polarization Q component output), and h_{x_qq} represents a filter coefficient vector (X-polarization Q component input/X-polarization Q component output). In the coefficient multiplication unit 2381-2, h_{y_ii} represents a filter coefficient vector (Y-polarization i component input/Y-polarization i component output), h_{y_iq} represents a filter coefficient vector (Y-polarization Q component input/Y-polarization i component output), h_{y_qi} represents a filter coefficient vector (Y-polarization i component input/Y-polarization Q component output), and h_{y_qq} represents a filter coefficient vector (Y-polarization Q component input/Y-polarization Q component output). x_{i_out}(n), x_{q_out}(n) output from the IQ skew compensation unit 238-1 and y_{i_out}(n), y_{q_out}(n) output from the IQ skew compensation unit 238-1 can be expressed by the following Expressions (7).

$$[ Math . 7 ]$$

$$\begin{matrix}{x}_{i \_ out} ( n ) = & {x}_{i \_ in} ( n ) \cdot & {h}_{x \_ ii} + & {x}_{q \_ in} ( n ) \cdot & {h}_{x \_ qi} \\ {x}_{q \_ out} ( n ) = & {x}_{i \_ in} ( n ) \cdot & {h}_{x \_ qi} + & {x}_{q \_ in} ( n ) \cdot & {h}_{x \_ qq} \\ {y}_{i \_ out} ( n ) = & {y}_{i \_ in} ( n ) \cdot & {h}_{y \_ ii} + & {y}_{q \_ in} ( n ) \cdot & {h}_{y \_ iq} \\ {y}_{q \_ out} ( n ) = & {y}_{i \_ in} ( n ) \cdot & {h}_{y \_ qi} + & {y}_{q \_ in} ( n ) \cdot & {h}_{y \_ qq} \\ {≀}_{{Real number}_{scalar}} & {≀}_{{Real number}_{vector}} & {≀}_{{Real number}_{vector}} & {≀}_{{Real number}_{vector}} & {≀}_{{Real number}_{vector}}\end{matrix} \qquad ( 7 )$$

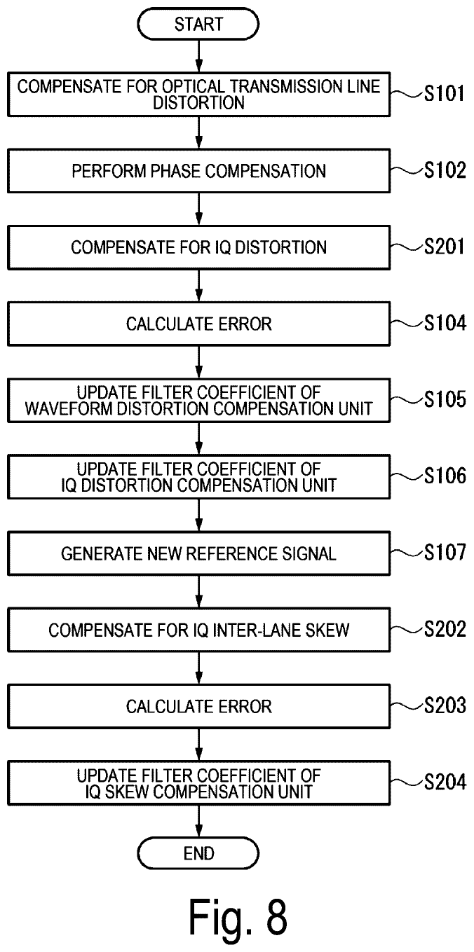

FIG. 8 is a flowchart illustrating a flow of signal processing performed by the digital signal processing unit 23a in the second embodiment. In FIG. 8, processing steps similar to those in FIG. 5 are denoted by similar reference numerals to those in FIG. 5, and description thereof is omitted.

After the processes in steps S101 and S102, the IQ distortion compensation unit 233a-1 compensates for IQ imbalance and DC offset of an X-polarization I component signal and an X-polarization Q component signal subjected to phase compensation, which are output from the phase compensation unit 232-1. The IQ distortion compensation unit 233a-1 outputs the X-polarization I component signal and the X-polarization Q component signal subjected to IQ imbalance and DC offset compensation to the error calculation unit 234-1 and the IQ skew compensation unit 238-1. The IQ distortion compensation unit 233a-2 compensates for IQ imbalance and DC offset of a Y-polarization I component signal and a Y-polarization Q component signal subjected to phase compensation, which are output from the phase compensation unit 232-2. The IQ distortion compensation unit 233a-2 outputs the Y-polarization I component signal and the Y-polarization Q component signal subjected to IQ imbalance and DC offset compensation to the error calculation unit 234-2 and the IQ skew compensation unit 238-2 (step S201).

The IQ skew compensation unit 238-1 compensates for IQ inter-lane skews of the X-polarization I component signal and the X-polarization Q component signal subjected to IQ imbalance and DC offset compensation, which are output from the IQ distortion compensation unit 233a-1. The IQ skew compensation unit 238-1 outputs the X-polarization I component signal and the X-polarization Q component signal subjected to IQ inter-lane skew compensation to the subsequent processing unit and the error calculation unit 239-1. The IQ skew compensation unit 238-2 compensates for IQ inter-lane skews of the Y-polarization I component signal and the Y-polarization Q component signal subjected to IQ imbalance and DC offset compensation, which are output from the IQ distortion compensation unit 233a-2. The IQ skew compensation unit 238-2 outputs the Y-polarization I component signal and the Y-polarization Q component signal subjected to IQ inter-lane skew compensation to the subsequent processing unit and the error calculation unit 239-2 (step S202).

The error calculation unit 239-1 calculates the error between the X-polarization I component signal and the X-polarization Q component signal subjected to IQ inter-lane skew compensation, which are output from the IQ skew compensation unit 238-1. The error calculation unit 239-1 outputs the calculated X-polarization error to the IQ skew compensation coefficient updating unit 240-1. The error calculation unit 239-2 calculates the error between the Y-polarization I component signal and the Y-polarization Q component signal subjected to IQ inter-lane skew compensation, which are output from the IQ skew compensation unit 238-2. The error calculation unit 239-2 outputs the calculated Y-polarization error to the IQ skew compensation coefficient updating unit 240-2 (step S203).

The IQ skew compensation coefficient updating unit 240-1 updates the filter coefficients h_{x_ii}, h_{x_iq}, h_{x_qi}, h_{x_qq} used in the IQ skew compensation unit 238-1 using the error output from the error calculation unit 239-1. The IQ skew compensation coefficient updating unit 240-1 outputs the updated filter coefficients to the IQ skew compensation unit 238-1. The IQ skew compensation coefficient updating unit 240-2 updates the filter coefficients h_{y_ii}, h_{y_iq}, h_{y_qi}, h_{y_qq} used in the IQ skew compensation unit 238-2 using the error output from the error calculation unit 239-2. The IQ skew compensation coefficient updating unit 240-2 outputs the updated filter coefficients to the IQ skew compensation unit 238-2 (step S204).

According to the optical transmission system 100 of the second embodiment with the above configuration, effects similar to those of the first embodiment can be obtained.

Furthermore, in the optical transmission system 100 according to the second embodiment, the IQ distortion compensation unit 233a-1, 233a-2 compensates for the IQ imbalance and the DC offset, and the IQ skew compensation unit 238-1 and the IQ skew compensation unit 238-2 provided at the subsequent stage of the IQ distortion compensation unit 233a-1, 233a-2 compensate for the IQ inter-lane skew. As described above, in the second embodiment, the IQ inter-lane skew can also be compensated. Therefore, the signal quality can be further improved in the presence of the IQ inter-lane skew.

### (First Modification)

In the above embodiment, the phase compensation unit 232-1, 232-2 is provided at the subsequent stage of the waveform distortion compensation unit 231 in the digital signal processing unit 23a, but the phase compensation unit 232-1, 232-2 may be provided at the preceding stage of the waveform distortion compensation unit 231, or may be provided at each of the preceding stage and the subsequent stage of the waveform distortion compensation unit 231.

### (Second Modification)

In an environment in which the IQ inter-lane skew is small, the digital signal processing unit 23a may be configured to independently stop the IQ skew compensation unit 238-1, 238-2 and not perform IQ inter-lane skew compensation. With such a configuration, power can be suppressed. Here, the environment in which the IQ inter-lane skew is small means a case where the influence is small even if the IQ inter-lane skew is not compensated.

### (Comparison of Configurations in Individual Embodiments)

When the configuration of the first embodiment, the configuration of the second modification of the first embodiment, and the configuration of the second embodiment are compared in terms of compensation performance and power (circuit scale or the like), the following relationship is obtained.

### [Compensation Performance]

(GOOD) Configuration of Second Modification of First Embodiment>Configuration of Second Embodiment>Configuration of First Embodiment (BAD) [Power (=~ Circuit Scale)]
(Small: GOOD) Configuration of First Embodiment>Configuration of Second Embodiment>Configuration of Second Modification of First Embodiment (Large: BAD)

As described above, the configuration of the second modification of the first embodiment has the best compensation performance but has the highest power. The configuration of the first embodiment has the lowest compensation performance but can minimize power. As described above, the most efficient operation can be performed by selectively using the configuration of the first embodiment, the configuration of the second modification of the first embodiment, and the configuration of the second embodiment depending on the application.

Some functions of the optical reception device 20 in the embodiments described above may be implemented by a computer. In that case, a program for implementing the functions may be recorded in a computer-readable recording medium, and the program recorded in the recording medium may be read and executed by a computer system to implement the functions. Note that “computer system” herein includes hardware such as an operating system (OS) and peripheral devices. “Computer-readable recording medium” refers to a portable medium such as a flexible disk, a magneto-optical disk, a read only memory (ROM), or a CD-ROM, or a storage device such as a hard disk included in a computer system.

Furthermore, “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. The program may be for implementing some of the functions described above, may be implemented by a combination of the functions described above and a program already recorded in a computer system, or may be implemented with a programmable logic device such as a field-programmable gate array (FPGA).

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention can be applied to an optical transmission system technology that performs equalization processing using a digital filter.

### REFERENCE SIGNS LIST

10 Optical transmission device
11 Optical transmission unit
12 Electrical signal generation unit
13 Optical signal generation unit
20 Optical reception device
21 Optical reception unit
22 Coherent optical reception unit
23, 23a Digital signal processing unit
30 Optical transmission line
31 Optical fiber
32 Optical amplifier
231 Waveform distortion compensation unit
232-1, 232-2 Phase compensation unit
233-1, 233-2, 233a-1, 233a-2 IQ distortion compensation unit
234-1, 234-2, 239-1, 239-2 Error calculation unit
235-1, 235-2 Waveform distortion compensation coefficient updating unit
236-1, 236-2 Reference signal processing unit
237-1, 237-2 IQ distortion compensation coefficient updating unit
238-1, 238-2 IQ skew compensation unit
240-1, 240-2 IQ skew compensation coefficient updating unit

1. An optical reception device comprising:
a coherent optical receiver configured to receive a polarization multiplexed signal generated on the basis of a digital modulation signal generated by phase modulation or quadrature amplitude modulation with coherent detection;
a waveform distortion compensator configured to compensate for a transmission line distortion generated in an optical transmission line with respect to the polarization multiplexed signal;
a plurality of IQ distortion compensators configured to compensate for at least an IQ imbalance or a DC component offset of a signal subjected to transmission line distortion compensation;
a plurality of error calculators configured to calculate each polarization error obtained from an output signal of each of the IQ distortion compensators; and
a plurality of coefficient updaters configured to update a filter coefficient used in the waveform distortion compensator and filter coefficients used in the plurality of IQ distortion compensators on the basis of a method of determining a filter coefficient on the basis of a model that minimizes a mean square value of each polarization error calculated by each of the plurality of error calculators, or a method of searching for a filter coefficient for obtaining a minimum value of a mean square error based on an instantaneous value of an error.

2. The optical reception device according to claim 1, further comprising
a plurality of phase compensators configured to compensate for phase rotation of each polarized signal at least at a preceding stage or a subsequent stage of the waveform distortion compensator.

3. The optical reception device according to claim 2, further comprising
a plurality of reference signal processors configured to convert a known reference signal used for updating an amount of compensation in the plurality of phase compensators by affine transformation using a filter coefficient used in each of the plurality of IQ distortion compensators to generate a new reference signal.

4. The optical reception device according to claim 1, wherein
the plurality of IQ distortion compensators further compensate for an IQ inter-lane skew of a signal subjected to transmission line distortion compensation.

5. The optical reception device according to claim 1, further comprising:
a plurality of IQ skew compensators configured to compensate for an IQ inter-lane skew at a subsequent stage of the IQ distortion compensator;
a plurality of error calculators configured to calculate each polarization error obtained from an output signal of each of the IQ skew compensators; and
a plurality of IQ skew compensation coefficient updaters configured to update filter coefficients used in the plurality of IQ skew compensators on the basis of a method of determining a filter coefficient on the basis of a model that minimizes a mean square value of each polarization error calculated by each of the plurality of error calculators, or a method of searching for a filter coefficient for obtaining a minimum value of a mean square error based on an instantaneous value of an error.

6. The optical reception device according to claim 1, wherein
the plurality of coefficient updaters update a filter coefficient used in the waveform distortion compensator on the basis of a value obtained by transforming each polarization error by a linear process using a filter coefficient used in each of the plurality of IQ distortion compensators.

7. A signal processing method comprising:
receiving a polarization multiplexed signal generated on the basis of a digital modulation signal generated by phase modulation or quadrature amplitude modulation with coherent detection;
compensating for a transmission line distortion generated in an optical transmission line with respect to the polarization multiplexed signal;
compensating for at least an IQ imbalance or a DC component offset of a signal subjected to transmission line distortion compensation;
calculating each polarization error obtained from an output signal subjected to IQ imbalance or DC component offset compensation; and
updating a filter coefficient used to compensate for the transmission line distortion and a filter coefficient used to compensate for at least the IQ imbalance or the DC component offset on the basis of a method of determining a filter coefficient on the basis of a model that minimizes a mean square value of each polarization error calculated, or a method of searching for a filter coefficient for obtaining a minimum value of a mean square error based on an instantaneous value of an error.
